(19) United States
(12) Patent Application Publication
(10) Pub. No.: US 2017/0197461 A1
(43) Pub. Date: Jul. 13, 2017

(54) Water Drain Holes For Wheels Having A Hollow Rim

(71) Applicant: Raymond Anderson Scruggs, San Anselmo, CA (US)

(72) Inventor: Raymond Anderson Scruggs, San Anselmo, CA (US)

(21) Appl. No.: 14/990,741

(22) Filed: Jan. 7, 2016

(51) Int. Cl. B60B 21/02; B60B 21/06

(52) U.S. Cl. CPC B60B 21/025; B60B 21/062; B60B 21/06; B60B 2360/102; B60B 2360/104; B60B 2360/108; B60B 2360/32; B60B 2360/3416; B60B 2900/111; B60B 2900/212; B60B 2900/141

(57) ABSTRACT

Water drain holes, located through the sidewalls of hollow rims for vehicle wheels not sealed from water ingress, is described herein to provide an egress for accumulated water. The water drain holes in a wheel rim can be for any type of vehicle utilizing a hollow rim design for wheels when not sealed from water ingress. Without drain holes, accumulated water inside a hollow rim adds significant weight, which produces undesirable effects, such as resistance to the vehicle driver input to accelerate, steer, and otherwise control the vehicle, such as but not limited to a bicycle. Also, accumulated water inside a hollow rim enables increased galvanic current conductivity, producing corrosion.

### BACKGROUND

A vehicle wheel rim retains a tire in place, and provides attachment points for spokes or other means of securing an axle hub. Some rims are hollow in design, such as the majority of currently available bicycle rims. A hollow rim has an advantage in stiffness for a given rim weight. The hollow rim is much like a tube of material, rolled or molded or fabricated otherwise into a round rim for a rolling wheel. Physically, a formed tube of solid material is stiffer than a solid rod, when each are the same length, weight, and material. A stiffer hollow rim can can resist flex and support more weight loads with less deflection that a rim which is not hollow, such as, a single-wall rim of “U”, “I”, or “H” shape.

A problem for hollow rims that are not water and air sealed, a common problem of rims utilizing spokes or other openings in the hollow rim, is water ingress and retention inside the hollow rims for many weeks and months, after washing, or while used in rain, or crossing flooded streets, or crossing streams. The accumulated water inside a hollow rim adds significant weight, which produces undesirable effects, such as resistance to wheel acceleration or braking, wheel imbalance, and can noticeably reduce the responses to force input to accelerate, steer, and otherwise control the vehicle, such as but not limited to a bicycle.

Another significant problem if water enters a hollow rim, then the water enables galvanic current conductivity when there are two or more galvanic current enabling materials, producing corrosion. For example when steel spokes of a bicycle are secured to a rim by aluminum alloy nipples, the aluminum nipples corrode when water enables electron galvanic current conductivity.

### BRIEF SUMMARY OF THE INVENTION

Holes specifically located through the sidewalls of hollow rims for wheels, when the hollow rim is not sealed from water ingress, are designed to provide an egress, water drain holes for the accumulated water is described. The water drain holes in a wheel rim can be for any type of vehicle utilizing a hollow rim design having openings in the rim allowing water accumulation inside the hollow area. The wheel rim can be produced from materials providing suitable mechanical properties, such as carbon fiber, aluminum alloy, metal alloy, steel, titanium, or other suitable materials.

The invention herein described provides one to many openings through the sidewall of a hollow rim for water to, and drain out of the hollow rim while the vehicle wheel is rolling or stationary. The rim wall hole or holes can be situated near the outermost radius of the rim's inside hollow diameter for optimum water drainage. The water drain holes provide an egress for accumulated water while the rim is rolling by centrifugal forces and gravity, or while the wheel is stationary and the drain hole or holes of the rim are intentionally located to be situated closest or lowest to the floor or ground so that water drains from the rim due to gravity.

### BRIEF DESCRIPTION OF THE DRAWINGS

The accompanying drawings or diagrams illustrate the areas of specification and various examples of execution of the descriptions herein. The illustrated examples are merely examples and do not limit the scope of the claims.

FIG. 1 is a diagram of prior art. An illustrative example of a hollow bicycle wheel rim profile. And the illustration includes a common use of spokes and nipples that connect a hollow rim to a wheel hub. The crossing wall to the rim have various profile contours to support and secure a tire, and is sealed so that no water or air can enter the hollow formed rim.

FIG. 2 is an illustrative example of a side view of a rim sidewall that includes small round water drain holes according to principles described herein.

FIG. 3 is an illustrative example of a side view of a rim sidewall that includes examples of various hole shapes of water drain holes according to principles described herein.

FIG. 4 is an illustrative example of a hollow bicycle wheel rim profile that includes water drain holes according to principles described herein. The drain holes are illustrated while the wheel locates the rim water drain holes at the bottom of a wheel in a vertical upright position, near a floor or other surface terrain.

FIG. 5 is an illustrative example of a hollow bicycle wheel rim profile that includes water drain holes according to principles described herein. The water drain holes are illustrated near the lowest surface of the rim while the wheel is located in a horizontal position, on a floor or other surface terrain.

Throughout the drawings, identical reference numbers designate identical elements.

### DETAILED DESCRIPTION

As noted above, a wheel rim retains a tire in place, and provide attachment points for spokes or other means of securing an axle hub. Some rims are hollow in design, such as the majority of currently available bicycle rims. A hollow rim has an advantage in stiffness for a given rim weight. In hollow rims spokes or other openings in the hollow rim wall allow water ingress, and store accumulated water, adding weight and accelerating corrosion as a result of galvanic current conductivity.

The rim invention herein described provides one to many openings through the rim sidewall for water to egress and drain, while the vehicle wheel is rolling or while at rest. The rim wall drain hole or holes can be situated near the outermost radius of the rim's inside hollow diameter for optimum water drainage. The water drain holes provide an exit for accumulated water while the rim is rolling by centrifugal forces and gravity, or while the wheel is stationary and the drain hole or holes of the rim are intentionally located to be situated closest or lowest to the floor or ground surface so that water drains from the rim due to gravity.

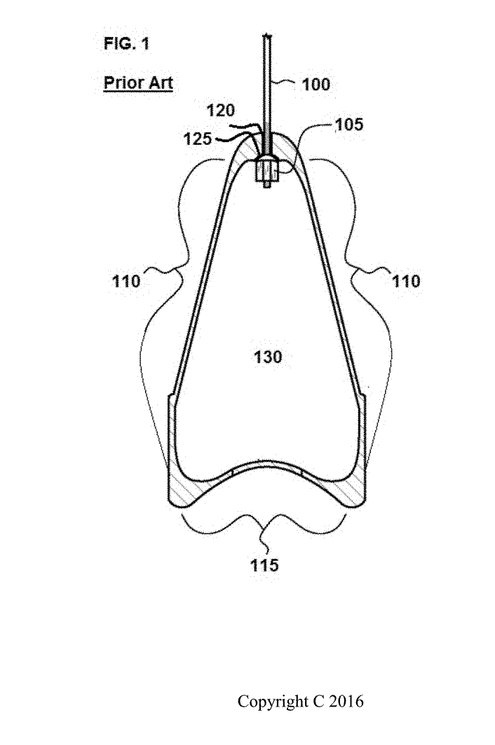

FIG. 1 is a diagram of prior art. An illustrative example of a hollow bicycle wheel rim profile. And the illustration includes a common use of spokes 100 and nipples 105 that connect a hollow rim to a wheel hub. The sidewalls 110 of a hollow rim provide vertical load bearing strength. The crossing wall 115 provides lateral load bearing strength and supports the tire to the rim. The crossing wall 115 to the rim have various profile contours to support and secure a tire, and is sealed so that no water or air can enter the hollow formed rim. The tire supporting crossing wall may be a solid wall; or if not solid wall then plastic tape to cover spoke nipple access holes, or a tire inner tube, or other suitable seal of the tire supporting rim wall rim is made to seal the pressurized air from the tire from ingress into the hollow area of the rim. When a wheel is not one solid piece from axle hub to tire rim, commonly removable spokes 100 and nipples 105 are utilized to lighten weight. And a hollow rim requires spoke holes 120, and optionally a counter-sunk chamfer 125 into a thicker strong spoke-bed section of rim wall supporting spoke and nipple tension with the wheel hub. The whole rim, spoke-bed section, sidewalls, and tire supporting crossing wall, form an example of a hollow rim profile 130, commonly utilized for current bicycle rims, and increasingly utilized for light weight motor powered vehicles.

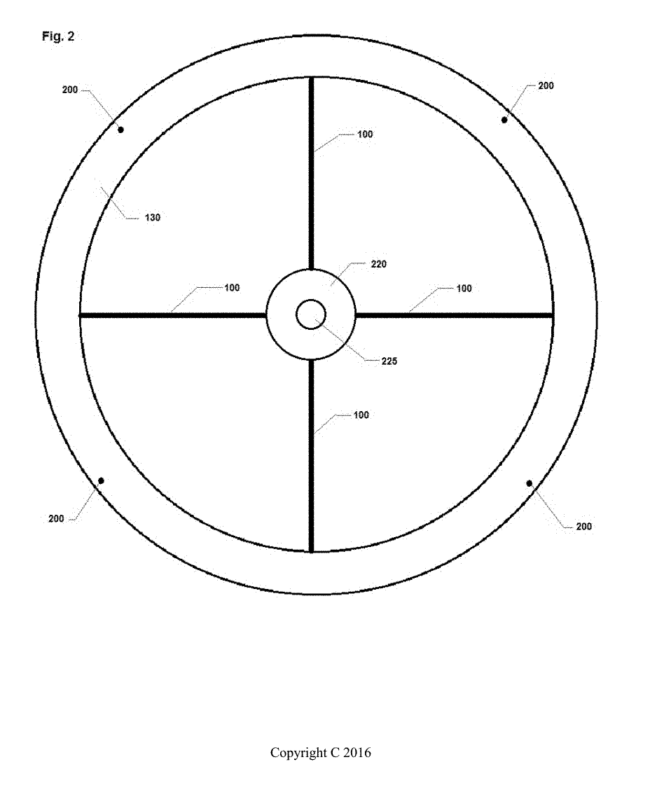

FIG. 2 is a side view of a hollow rim 130 that includes small round water drain holes 200 according to principles described herein. Some or all holes through the outside facing rim walls, are optimally located so that the outermost distance of the drain hole from the rim axial center is close or intersecting the maximum diameter of the inside hollow section. A hollow rim 130 is commonly secured by spokes 100 to a hub 220 having a hole bored 225 to secure the wheel to the vehicle with an axle or spindle.

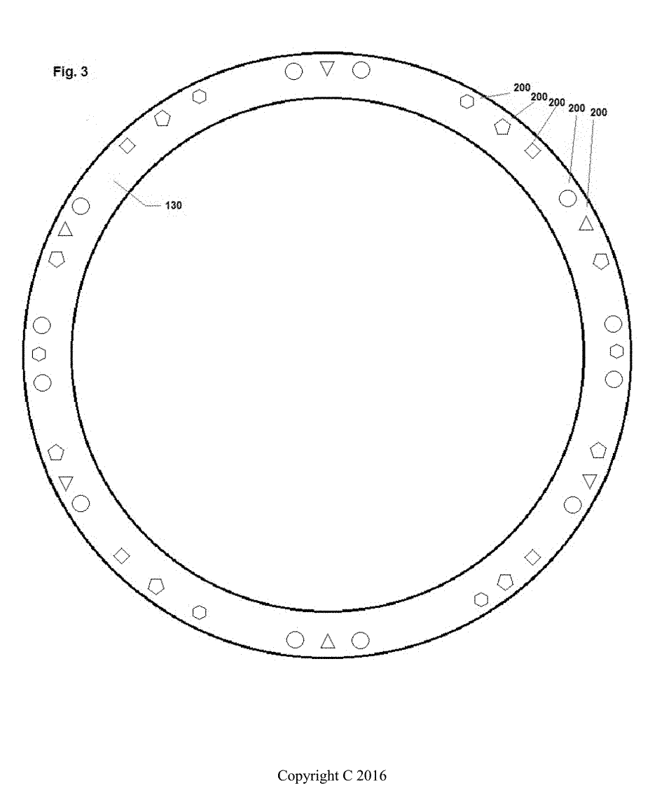

FIG. 3 is a side view of a hollow rim 130 that includes examples of various hole shapes of water drain holes according to principles described herein 200 some or all holes through the outside facing rim walls, are optimally located so that the outermost distance of the drain hole from the rim axial center is close or intersecting the maximum diameter of the inside hollow section.

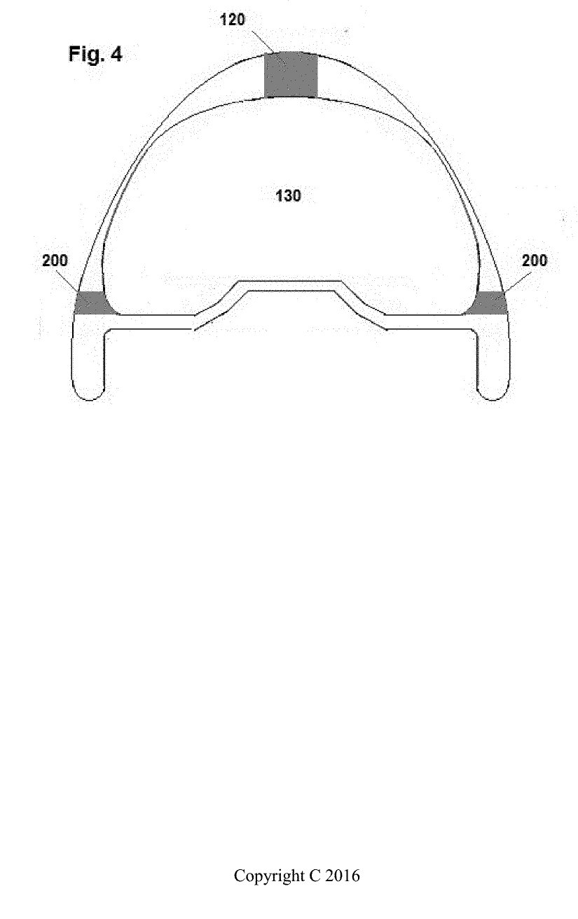

FIG. 4 is an illustrative example of a hollow wheel rim profile 130, that includes water drain holes 200 according to principles described herein. The orientation of the drain holes are illustrated while the wheel locates the drain holes 200 at the bottom rotation or 6 o'clock orientation of a wheel in a vertical upright position, upon a floor or other surface terrain. The drain holes 200 provide an exit for accumulated water while the rim is rolling by centrifugal forces and gravity. The drain holes 200 provide an exit for accumulated water while the rim is stationary in a vertical position by force of gravity.

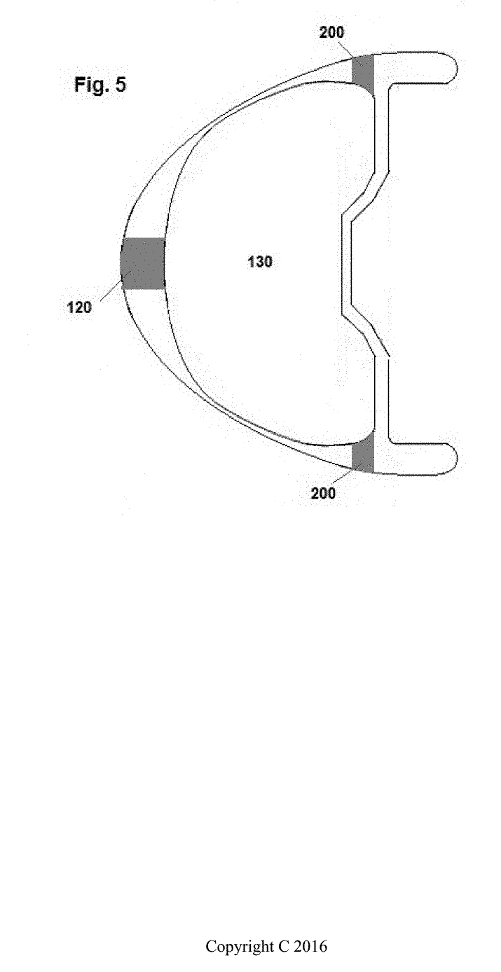

FIG. 5 is an illustrative example of a hollow wheel rim profile 130, that includes water drain holes 200 according to principles described herein. The water drain holes 200 are illustrated near the lowest surface of the rim while the wheel is located in a horizontal position, on a floor or other surface terrain. The drain holes 200 provide an exit for accumulated water while the rim is stationary and horizontal by force of gravity.

### PATENT CITATIONS

| Citing Patent | Filing date | Publication date | Applicant | Title |
|---|---|---|---|---|
| U.S. Pat. No. 446,189 | Dec. 24, 1889 | Feb. 10, 1891 | | Hollow wheel-rim |
| U.S. Pat. No. 758,190 | Sep. 8, 1903 | Apr. 26, 1904 | John F W Rethmeyer | Wheel-rim |
| U.S. Pat. No. 1,379,843 | Dec. 8, 1919 | May 31, 1921 | Erastus Williams William | Hollow-rolled-rim wheel |
| U.S. Pat. No. 1,387,529 | Sep. 18, 1919 | Aug. 16, 1921 | Erastus Williams William | Cast-steel-spoked wheel |
| U.S. Pat. No. 1,540,414 | Aug. 16, 1923 | Jun. 2, 1925 | Leon Montupet | Wheel for automobiles or |
| | | | | other vehicles |
| U.S. Pat. No. 3,369,844 | Feb. 2, 1966 | Feb. 20, 1968 | Hamilton Cosco Inc | Spoked wheel and resilient |
| | | | | tire therefor |
| U.S. Pat. No. 5,080,444 | Nov. 29, 1989 | Jan. 14, 1992 | E. I. Du Pont De Nemours | Vehicle wheel |
| | | | And Company | |
| U.S. Pat. No. 5,184,874 | May 17, 1991 | Feb. 9, 1993 | Olson Paul D | Injection molded plastic |
| | | | | bicycle wheel |
| U.S. Pat. No. 7,137,675 | Sep. 17, 2004 | Nov. 21, 2006 | Gs Engineering, Inc. | Road wheel for tracked |
| | | | | vehicles |
| U.S. Pat. No. 6,402,256 | Sep. 5, 2000 | Jun. 11, 2002 | Mavic S. A. | Bicycle rim and wheel having |
| | | | | such a rim |
| U.S. Pat. No. 8,297,325 | Jun. 11, 2009 | Oct. 30, 2012 | Olivier Phely, Denis Piou | Semi-hollow pneumatic tyre |
| | | | | and associated wheel rim, |
| | | | | notably for agricultural machinery |

1. A wheel rim comprising a hollow design, sometimes called “double-wall” design, wherein the side walls have water drain holes. The hollow rim sidewall holes are an egress, a drain from the inner area of the rim, allowing accumulated water which had ingress by spokes and nipples through the rim spoke bed holes. In hollow rims accumulated water is otherwise retained for long periods of time adding weight and accelerating corrosion due to galvanic current conductivity. The water drain holes may be in one or many locations of one or both sides of the rim. A bicycle rim is commonly constructed with a hollow rim design. The type of vehicle is not limited to bicycles.

2. The rim of claim 1, can be produced from any suitable material, for example metals such as aluminum alloy, steel, titanium; and composites such as carbon-fiber; plastic; and the like.

3. The rim of claim 1, having holes through the outside facing rim walls, are drilled or molded or otherwise implement through the rim sidewall into the inside hollow, with hole size no less than 0.10 of an inch to 2.50 inches in hole diameter, width or height.

4. The rim of claim 1, having some or all holes through the outside facing rim walls, are optimally located so that the outermost distance of the drain hole from the rim axial center is close or intersecting the maximum diameter of the inside hollow section.

5. The rim of claim 1, having drain holes of any geometric shape, such as round, triangular, or square holes.

6. The rim of claim 1, having drain holes provide an exit for accumulated water while the rim is rolling by centrifugal forces and gravity, or while the wheel is stationary and the drain hole or holes of the rim are intentionally located to be situated closest or lowest to the floor or ground surface so that water drains from the rim due to gravity.
